(19) United States
(12) Patent Application Publication
(10) Pub. No.: US 2011/0120792 A1
(43) Pub. Date: May 26, 2011

(54) AIR GUIDE DEVICE FOR FRONT FACE STRUCTURE OF VEHICLE

(75) Inventors: Matthieu Carron, Montigny Le Bretonneux (FR); Juliette Massoulie, Gambais (FR); Angel Ve Lasco, Voisins Le Bretonneux (FR)

(73) Assignee: RENAULT S. A. S., Boulogne-Billancourt (FR)

(21) Appl. No.: 12/988,565

(22) PCT Filed: Mar. 17, 2009
(86) PCT No.: PCT/FR2009/050445

§ 371 Date: Feb. 9, 2011

(30) Foreign Application Priority Data
Apr. 22, 2008 (FR) 0802232

(51) Int. Cl. B60K 11/08

(52) U.S. Cl. 180/68.1

(57) ABSTRACT

The invention relates to a device for guiding air from a vehicle front surface structure including heat exchangers (12) located in front of the engine, said device including two side diffusers (16, 18), to be disposed on either side of the heat exchangers, and a top diffuser (20), to be disposed on top of the heat exchangers, to guide the air entering through air inlets from the bumpers of the vehicle to the heat exchangers, and is characterized in that the side diffusers (16, 18) and the top diffuser (20) are provided with an attaching means capable of ensuring attachment of the top diffuser only on each of the side diffusers.

The invention relates to an air guide device for a front face structure of a vehicle, particularly a motor vehicle.

On the front face of a vehicle are air inlets allowing the entry of a stream of air to cool the engine. These air inlets consist of orifices formed in the front bumpers of the vehicle.

The engine is cooled by heat exchangers (radiator, air cooler, condenser) situated on the front face, in front of the engine, through which the air stream flows.

In order to direct the incoming air stream toward the heat exchangers, vehicles are usually fitted with convergers, which are usually plastic parts positioned in such a way as to guide the air from the air inlets of the bumpers to the heat exchangers. These convergers are thus positioned between the bumpers and the heat exchangers. The convergers may be divided into side convergers, arranged approximately vertically in the longitudinal direction of the vehicle, and the upper converger, arranged approximately horizontally along the upper edge of the heat exchangers.

The upper and side convergers are currently fixed directly to the heat exchangers, independently of each other. The problem with this method of assembly is that it makes it difficult to seal the interface between the side convergers and the upper converger. Furthermore, the side convergers tend to be pushed away from each other by the air stream because of their relative flexibility, which results in additional leaks.

It is now therefore becoming necessary to improve the air stream through the heat exchangers in order to improve their cooling performance and thus meet new pollution control regulations which have increased the cooling requirements of certain engines, such as diesel engines with automatic transmissions.

There is therefore a need to improve the airtightness of the region between the heat exchangers and the bumper in order to direct as much as possible of the incoming air stream to the heat exchangers and so improve the cooling of the engine.

It is an object of the invention to mitigate this problem by providing an air guide device comprising an upper converger fixed directly and only to the side convergers.

The advantage of such a mounting is to ensure airtightness at the interface between the side and upper convergers and prevent the side convergers being pushed open by the action of the air.

For this purpose the subject of the invention relates to an air guide device for a front face structure of a vehicle comprising heat exchangers situated forward of the engine, said device comprising two side convergers designed to be positioned on either side of the heat exchangers, and an upper converger designed to be positioned on the top of the heat exchangers, in order to guide the air entering via the air inlets of the vehicle's bumper to the heat exchangers, said device being characterized in that the side convergers and the upper converger are fitted with fixing means suitable for fixing the upper converger to each of the side convergers only.

It is therefore no longer necessary to fix the upper converger to the heat exchangers. The upper converger is fixed only to the side convergers, thus limiting the movements of the latter caused by the air stream.

The fixing means advantageously allow reversible fixing of the upper converger to the side convergers in order to allow disassembly of the upper converger. These fixing means may for example be devised and arranged in such a way as to provide sufficient support for the upper converger on the side convergers to seal the connection between the upper converger and the side convergers.

Advantageously, the device is provided with means for locating the upper converger on the side convergers.

More specifically, the locating means comprise at least one female receiving member positioned on each of the side convergers, and at least two male members on the upper converger, each male member being suitable for engagement with one of the female members.

Advantageously, the female receiving member is a slot formed in the upper edge of each side converger, and the male member is a tab suitable for insertion into said slot located on the side edge of the upper converger.

The locating means can thus be manufactured simply and cheaply.

Advantageously, the male and female members are positioned and designed in such a way as to allow the upper converger to be rotated relative to the side convergers about an essentially horizontal and transverse axis.

This feature facilitates the locating and mounting of the upper converger on the side convergers, before fixing the former to the latter.

Advantageously, the male and female members are designed in such a way as to allow a relative movement of the upper converger with respect to the side convergers in an essentially horizontal and transverse direction. The clearance this provides simplifies the mounting of the upper converger despite the observed variations in the positions of the side convergers from one vehicle to another.

Advantageously, the fixing means are situated on the upper edges of each of the lateral convergers and on the side edges of the upper converger.

The fixing means may for example be snap fastening means.

More specifically, the snap fastening means comprise at least one snap fastening tab suitable for engagement with at least one corresponding housing, said housing being frustoconically shaped to facilitate the insertion of the snap fastening tab.

The invention will now be described with reference to the non-restrictive appended drawings, in which:

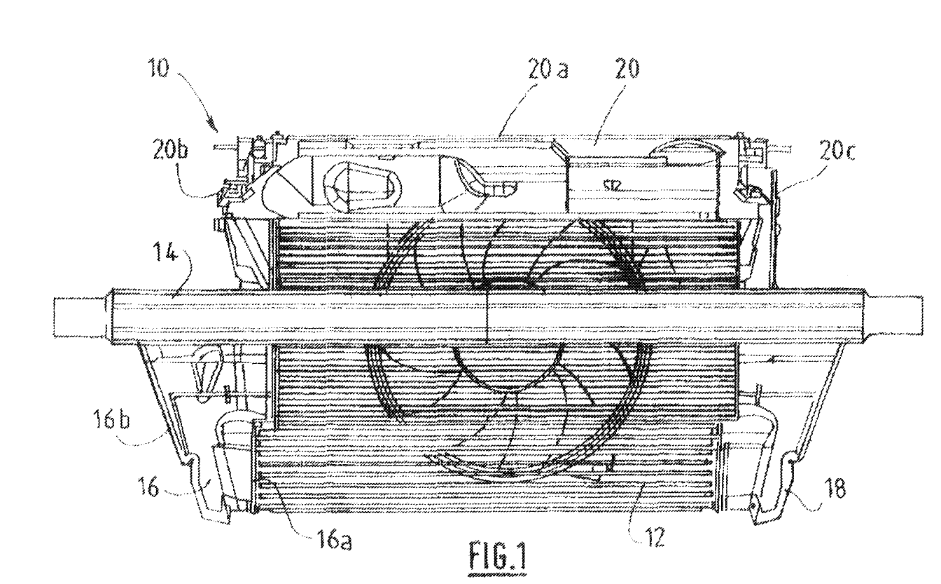

FIG. 1 is a front view of a front face structure of a motor vehicle showing an air guide device according to the invention;

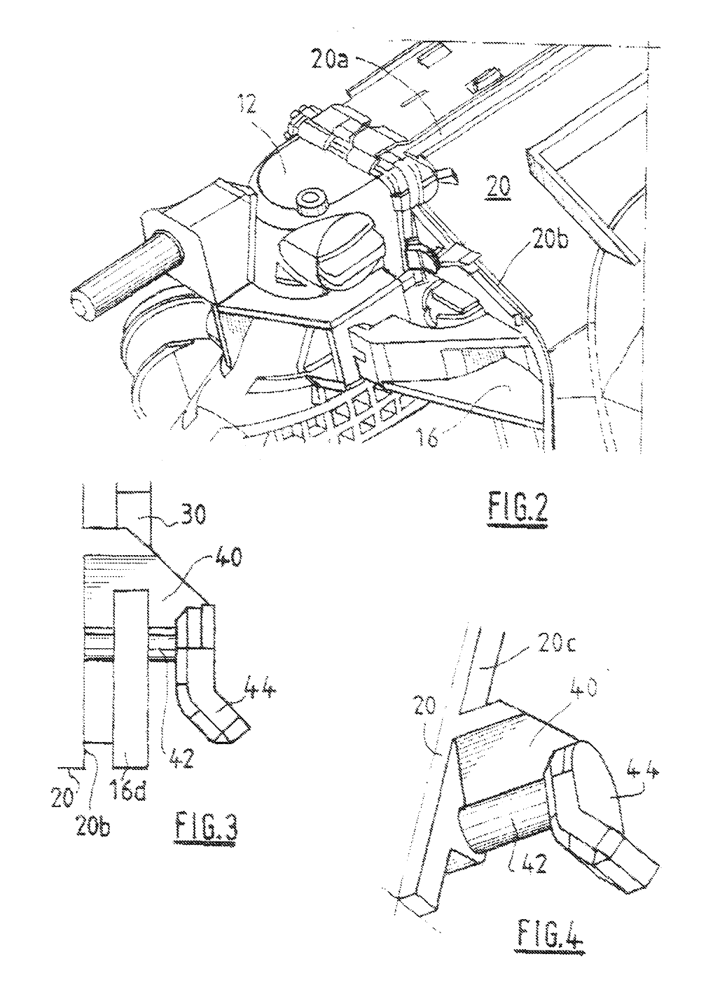

FIG. 2 is a perspective view of one side converger and the upper converger of the guide device shown in FIG. 1;

FIG. 3 is an enlargement of the locating means of the guide device shown in FIG. 1;

FIG. 4 shows an enlargement of the male member of the locating means from FIG. 3;

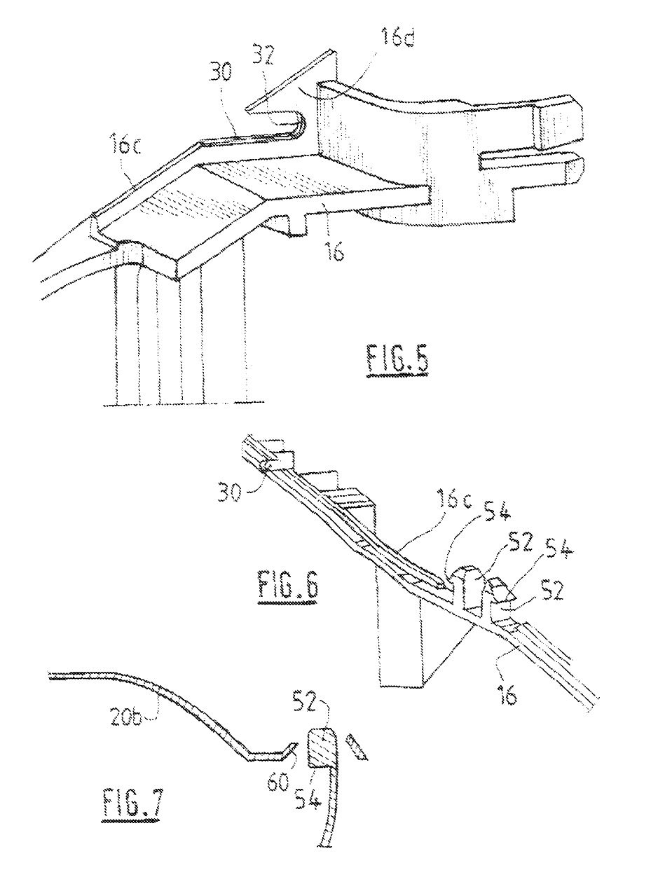

FIG. 5 shows an enlargement of the female member of the locating means from FIG. 3;

FIG. 6 is a perspective view of the top edge of a side converger for the guide device shown in FIG. 1; and

FIG. 7 is a cross section through the fixing means of a side converger and an upper converger.

In this description, the front and rear directions refer to the front and rear directions of the vehicle, and similarly the longitudinal and transverse directions denote the longitudinal and transverse directions of the vehicle.

FIG. 1 shows a front face structure 10 for a vehicle. It comprises heat exchangers 12 whose function is to cool the engine of the vehicle.

This front structure also includes an extreme front cross member 14 located between the heat exchangers 12 and the vehicle's front bumper (not shown).

Also visible in FIG. 1 are two side convergers 16, 18 and an upper converger 20. Their function is to guide the air entering via the air inlets of the vehicle's bumper to the heat exchangers 12, which are situated forward of the vehicle engine.

The air guide device according to the invention comprises the two side convergers 16, 18 and the upper converger 20. The side convergers 16, 18 are positioned on either side of the heat exchangers, essentially vertically, and the upper converger is positioned on the top of the heat exchangers, essentially horizontally.

The side convergers 16, 18 are symmetrical about a vertical longitudinal plane, so the structure of only one of these will be described with reference to the figures.

The side converger 16 is a single plate whose rear edge 16a is intended to bear against the heat exchangers 12, while the front edge 16b is intended to bear on the bumper (not shown) and the upper edge 16c is intended to receive the upper converger 20.

The upper converger 20 is also a single plate whose rear edge 20a is intended to bear on the top of the heat exchangers 12 while the side edges 20b and 20c are intended to bear against the side convergers 16 and 18, respectively.

According to the invention, the side convergers 16, 18 and the upper converger 20 are provided with fixing means suitable for fixing the upper converger to each of the side convergers.

In the example illustrated, the air guide device according to the invention is also provided with means for locating the upper converger from the side convergers.

These locating means comprise at least one female receiving member positioned on each of the side convergers, and at least two male members connected to the upper converger, each male member being suitable for engagement with one of the female members.

In the example illustrated, the female receiving member is a slot 30 formed in the upper edge of each side converger, and the male member is a tab 40 suitable for insertion into said slot located on the side edge of the upper converger.

In the example, the slot 30 extends essentially horizontally, as can be seen in FIG. 5, toward the front of the vehicle, when the side converger is mounted on the heat exchangers. This slot 30 is situated close to the upper end of the upper edge 16c of the side converger, as can be seen in FIG. 6. The closed end 32 of the slot is also in the shape of an arc of a circle (FIG. 5).

This slot 30 is designed to receive the tab 40 shown in FIGS. 3 and 4.

FIG. 3 is a top view of the tab 40 inserted into the slot 30 of the side converger 18. The tab 40 comprises a rear edge 42 of rounded section, suitable for engagement with the rounded closed end 32 of the slot. This rear edge 42 allows the tab 42 to be rotated in the slot 30, when only the rear edge 42 is inserted in the slot 30, the rear edges 42 of both tabs of the upper converger thus providing a transverse, essentially horizontal axis of rotation.

As can be seen in FIG. 3, the length of the rear edge 42 of each tab 40 is greater than the width (in the transverse direction) of that part 16d of the side converger 16 in which the slot 30 is formed. The length of the rear edge 42 may for example be at least twice as great as the width of the part 16d.

Relative movement of the upper converger with respect to the side convergers in an essentially horizontal and transverse direction is thus possible.

Additionally, the end of the rear edge 42 remote from the upper converger is provided with an arm 44 that extends rearward away from the edge 20b of the upper converger. This arm 44 guides and facilitates the insertion of the tab 40 into the corresponding slot 30.

These latter features are to absorb the variations that occur in assembly: the upper converger is fitted after the side convergers, which are relatively flexible parts and vary in geometry. Thus, in two identical vehicles, the actual positions of the side convergers may vary by a few millimeters. The length of the rear edge 42 and the shape of the arm 44 absorb these variations during the assembly of the upper arm.

In the example illustrated in the figures, the fixing means are situated on the upper edges of each of the side convergers and on the side edges of the upper converger.

These fixing means are snap fastening means.

In the illustrated example, the upper edge of each side converger 16, 18 is provided with two snap fastening tabs suitable for engagement in a corresponding housing formed in the corresponding side edge of the upper converger.

FIG. 6 shows the upper edge 16c of the side converger 16. This upper edge 16c has two snap fastening tabs 52 at the end of which is a projecting lip 54 to engage with the edge of the housing 60 on the side edge 20b of the upper converger, as shown in FIG. 7. In this latter figure, only one of the tabs 52 and the housing 60 are depicted, although in the example, both tabs 52 are inserted into the same housing 60. In a variant which is not shown, each tab could engage with a single corresponding housing. It will be observed that the housing 60 is frustoconical to facilitate the insertion of the snap fastening tab.

In the example illustrated, the housings 60 are holes that pass all the way through the upper converger in the vertical direction, thus allowing disengagement of the snap fastening tabs and removal of the converger.

In the example, the two snap fastening tabs 52 are situated close to each other, their lips 54 being turned in opposite directions. More precisely, these lips 54 are situated on the non-facing sides of the tabs. In the example, these faces are situated in essentially vertical and transverse planes.

Assembly of the upper converger 20 is done in the following manner, once the side convergers 16, 18 have been fixed to the heat exchangers 12.

The upper converger 20 is brought toward the side convergers 16, 18, and the rear edges 42 of the tabs 40 on either side of the upper converger are engaged in their respective slots 30. The upper converger is then positioned relative to the side convergers by pushing the upper converger rearward and/or transversely until the housings 60 are basically above the snap fastening tabs 52. The upper converger is then pivoted toward the side convergers until the tabs 52 engage with the corresponding housings 60.

The side edges of the upper converger and the upper edges of the side convergers are of essentially complementary shapes, so that the side edges of the upper converger bear on the upper edges of the side convergers, essentially all the way along the length of the latter. This limits leaks between the side and upper convergers. These edges may optionally be provided with flexible seals for improved leaktightness.

Preferably also, the fixing means will be situated at a distance from the locating means, to ensure good contact between the upper converger and the two side convergers.

In a variant that is not shown, the air guide device comprises only means for fixing the upper converger to the side convergers. In this variant the fixing means may for example be distributed along the edges of the convergers to provide regular contact between the upper converger and the side convergers. These fixing means may be similar to those described above. The fixing may also be by any other suitable means (screws, rivets or the like).

1-9. (canceled)

10. An air guide device for a front face structure of a vehicle including heat exchangers situated forward of the engine, the device comprising:
two side convergers configured to be positioned on either side of the heat exchangers; and
an upper converger configured to be positioned on a top of the heat exchangers, to guide air entering via air inlets of the vehicle's bumper to the heat exchangers;
wherein the side convergers and the upper converger include fixing means for fixing the upper converger to each of the side convergers only.

11. The air guide device as claimed in claim 10, further comprising locating means for locating the upper converger on the side convergers.

12. The guide device as claimed in claim 11, wherein the locating means comprises at least one female receiving member positioned on each of the side convergers, and at least two male members on the upper converger, each male member being configured for engagement with one of the female members.

13. The guide device as claimed in claim 12, wherein the female receiving member is a slot formed in the upper edge of each side converger, and the male member is a tab for insertion into the slot located on the side edge of the upper converger.

14. The guide device as claimed in claim 12, wherein the male and female members are positioned and configured to allow the upper converger to be rotated relative to the side convergers about an essentially horizontal and transverse axis.

15. The guide device as claimed in claim 12, wherein the male and female members are configured to allow a relative movement of the upper converger with respect to the side convergers in an essentially horizontal and transverse direction.

16. The guide device as claimed in claim 10, wherein the fixing means is situated on the upper edges of each of the lateral convergers and on the side edges of the upper converger.

17. The guide device as claimed in claim 10, wherein the fixing means comprises snap fastening means.

18. The guide device as claimed in claim 17, wherein the snap fastening means comprises at least one snap fastening tab for engagement with at least one corresponding housing, the housing being frustoconically shaped to facilitate insertion of the snap fastening tab.
